(19) United States
(12) Patent Application Publication
(10) Pub. No.: US 2008/0079548 A1
(43) Pub. Date: Apr. 3, 2008

(54) Non-Contact Power-Source-Less Ic Card System

(75) Inventors: Masahide Hayama, Kanagawa (JP); Hideyuki Nebiya, Tokyo (JP); Kotomi Uetake, Tokyo (JP)

Correspondence Address: DAY PITNEY LLP, 7 TIMES SQUARE, NEW YORK, NY, 10036-7311, US

(73) Assignee: AMPLET INC., Taito-ku, Tokyo (JP)

(21) Appl. No.: 10/537,527

(22) PCT Filed: Jul. 7, 2003
(86) PCT No.: PCT/JP03/08618

§ 371 Date: Oct. 13, 2005

(30) Foreign Application Priority Data
Dec. 4, 2002 (JP) 2002-352378

(51) Int. Cl. H04Q 5/22

(52) U.S. Cl. 340/10.4; 340/10.1

(57) ABSTRACT

In the conventional non-contact passive (power-source-less) IC card system method, a self-oscillator is built in a responder. The self-oscillator changes its oscillation frequency by the fluctuation of the power source voltage. Accordingly, it has been difficult to perform time management in the circuit in the responder. In order to solve this problem, in a carrier signal (micro wave) transmitted from an interrogator, the information to be transmitted is multiplexed by a clock frequency component reproduced by the responder. Upon reception of this, the responder extracts the clock frequency component from the modulated wave multiplexed and oscillates a stable frequency clock according to that component. Thus, it is possible to eliminate the problem that the information transfer rate of the circuit signal from the responder to the interrogator fluctuates according to the distance between the interrogator and the responder.

### BACKGROUND OF THE INVENTION

1. Field of the Invention

The present invention relates to an IC (integrated circuit) card system comprising an interrogator and a responder.

2. Description of the Prior Art

In recent years automatic-identification technology for objects has been widely used. The widely used bar-code system is a leading technology of the automatic-identification technologies for objects. However, this bar-code system does now allow information to be rewritten; thus, the non-contact IC card system, in which it is possible to rewrite and read information by utilizing electronic circuitry via wireless communication, has emerged.

The above non-contact IC card system, has focused on the RFID (Radio Frequency Identification) system, which is a non-contact passive IC card system utilizing a carrier signal providing a responder without a battery. In a typical embodiment of the above system, the carrier signal is transmitted to the passive IC card in another place, and the power source for operating a circuit of the responder is provided by the carrier signal. Moreover, in the system, information transmitted from the interrogator is written via the carrier signal, and stored in the responder, or information stored in an IC card is generated by the interrogator via the carrier signal. The construction thereof comprises, for example as shown in FIG. 6, the responder 0601 corresponding to the IC card, and the interrogator 0602.

Conventionally, there are three methods for generating a clock signal used in a processing circuit of the responder.

The first method is a method for generating the clock signal by separating the carrier from the interrogator. In this method, the clock signal is generated by the separating carrier, and a low-frequency such as LF band (30 kHz˜300 KHz) or HF band (3 MHz˜30 MHz) is used for the carrier.

Next, in the case that a comparatively high-frequency is used as a carrier, it is difficult to generate a clock signal by the first method. Because the frequency of the carrier is high and it is not suitable for an RFID system to separate the high-frequency signal, which requires a measurable amount of power. Accordingly, a method for generating the clock signal by arranging a local self-oscillation apparatus in the responder has been utilized as the second method. In a method for self-oscillation by a crystal oscillator etc. it is possible to generate a clock signal having a stable frequency. However, since the crystal oscillator circuit is required large space on the printed-circuit board, it is difficult to miniaturize the local self-oscillation apparatus, and to apply this method to a small IC chip utilizing microwave as a carrier, of which the size is typically 1 mm square. Because it requires use of a crystal oscillator, of which physical size is relative to wavelength, and there is a theoretical limit based on the wavelength in miniaturizing a crystal oscillator.

Finally, another method, in cases where the carrier signal has a comparatively short wavelength, will be described. In this method, a local self-oscillation apparatus is arranged in the responder, and the self-oscillation is performed by a combination of a capacitor, a resistor, and an inductor. This method is suitable for miniaturization and enables high-speed communication in the RFID system utilizing a microwave frequency as a carrier. However, the voltage generated in the responder fluctuates according to the communication distance between the responder and the interrogator, which influences the oscillator made up of a capacitor, a resistor, and an inductor. As a result, the unstable oscillation frequency ensued, which was indeed problematic.

FIG. 5 is a block diagram of the conventional non-contact passive (battery-less) IC card system, in which the self-oscillation type local oscillation unit is utilized in the responder. The responder 0501 comprises the oscillator unit of carrier signal 0502, the oscillator unit of transmitting signal 0503, and the transmitter unit of interrogator 0504. The responder comprises the receiver unit of the responder 0505, the signal processing unit 0506, the power recovery circuit unit 0507, the self-oscillation unit 0508, and the logic circuit 0509.

The carrier signal 0510 is transmitted between the interrogator 0501 and the responder. (Japanese Patent Publication No. H09-233611)

Next, the operation of the conventional non-contact passive IC card system will be described.

The carrier signal 0510 (e.g. microwave) modulated by the information in the interrogator 0501 or a non-modulated wave is transmitted from the transmitter unit of interrogator 0504 (e.g. transmitting antenna) to the responder as the carrier signal 0510. In the responder, the carrier signal 0510 received by the receiver unit of the responder 0505 (e.g. reception antenna) is distributed, and one portion thereof is inputted to the signal processing unit 0506 (e.g. microwave circuit) and another portion thereof is inputted to the power recovery circuit unit 0507. The power generated by the power recovery circuit unit 0507 is supplied to the signal processing unit 0506, the self-oscillation unit 0508, and the logic circuit 0509 etc. Here, the self-oscillation unit 0508 (e.g. CR type oscillation apparatus using a capacitor and a resistor, or LC type oscillation apparatus using an inductor and a capacitor) performs as a clock generator performing all time management in the responder, and the clock is inputted to the logic circuit 0509. As the communication distance between the interrogator and the responder becomes long, energy attenuation increases. Therefore, the power voltage recovered by the power recovery circuit unit 0507 fluctuates depending on the distance between the interrogator and the responder. However, in case of the non-contact passive IC card system utilizing a microwave frequency, it is difficult to provide a voltage stabilization circuit etc. for operation at the power voltage limit. Therefore, the oscillation frequency of the self-oscillation unit 0508 changes depending on the fluctuation of the recovered power supply voltage, and the information transmission rate of the response signal from the responder to the interrogator 0501 fluctuates depending on the distance between the responder and the interrogator 0501.

In the conventional non-contact passive IC card system, wherein high-frequency, such as microwave, is used as a carrier; and a self-oscillation apparatus is used in the responder. This self-oscillation apparatus changes the oscillation frequency thereof depending on the power supply voltage. Meanwhile, in cases where the power is generated by the carrier signal (e.g. microwave) transmitted from the interrogator, the recovered power supply voltage thereof significantly depends on the distance between the interrogator and the responder, and the frequency of the self-oscillation unit becomes unstable, thereby causing fluctuation in the information transmission rate of the communication. Moreover, in the passive IC card system operated at extreme low-voltage, the voltage stabilization circuit is unable to be provided. Accordingly, since the self-oscillation apparatus fluctuates the oscillation frequency thereof, it is difficult to perform time management of the circuit in the responder.

### SUMMARY

The present invention resolves the above deficiency, wherein the clock frequency component reproduced in the responder is multiplexed the carrier signal (e.g. microwave) transmitted from the interrogator other than essential information to be transmitted, and the responder receives the modulated signal, which is multiplexed, and extracts clock frequency component there from, and a stable frequency clock is oscillated based on the component.

The invention of Claim 1 for achieving the above objective is a non-contact passive IC card system comprising an interrogator, and a responder; wherein said interrogator comprises a generation unit for generating a carrier signal by utilizing microwave as a carrier, a generation unit for generating a clock signal for time management of a circuit in said responder, a generation unit for generating a transmitting signal by multiplexing the carrier signal generated by said generation unit for generating a carrier signal and the clock signal generated by said generation unit for generating a transmitting signal, and a transmitter unit for transmitting a transmitting wave generated by said generation unit for generating a transmitting signal; and said responder comprises a receiver unit of the responder for receiving the transmitting signal from the transmitter unit of said interrogator, a signal processing unit for processing the transmitting signal received from said receiver unit of the responder, a power recovery circuit unit for generating power supply by the transmitting signal received from said receiver unit of the responder, an extraction unit of clock frequency component for extracting a frequency component of said clock signal by the transmitting signal received from said receiver unit of the responder, and a clock generation unit for time management of a circuit in said responder by the clock frequency component extracted by said extraction unit of clock frequency component; thereby resolving the deficiency that a clock frequency in the responder fluctuates and the information transmission rate of the circuit signal from the responder to the interrogator fluctuates depending on the distance between the responder and the interrogator.

### BRIEF DESCRIPTION OF THE DRAWINGS

FIG. 1 is the first functional block diagram of the non-contact passive IC card system of the present invention.

FIG. 2 is the first functional block diagram of the power recovery circuit and the clock-frequency extraction unit of the present invention.

FIG. 3 is the second functional block diagram of the non-contact passive IC card system of the present invention.

FIG. 4 is the second functional block diagram of the power recovery circuit and the clock-frequency extraction unit of the present invention.

FIG. 5 is a functional block diagram of the conventional non-contact passive IC card system.

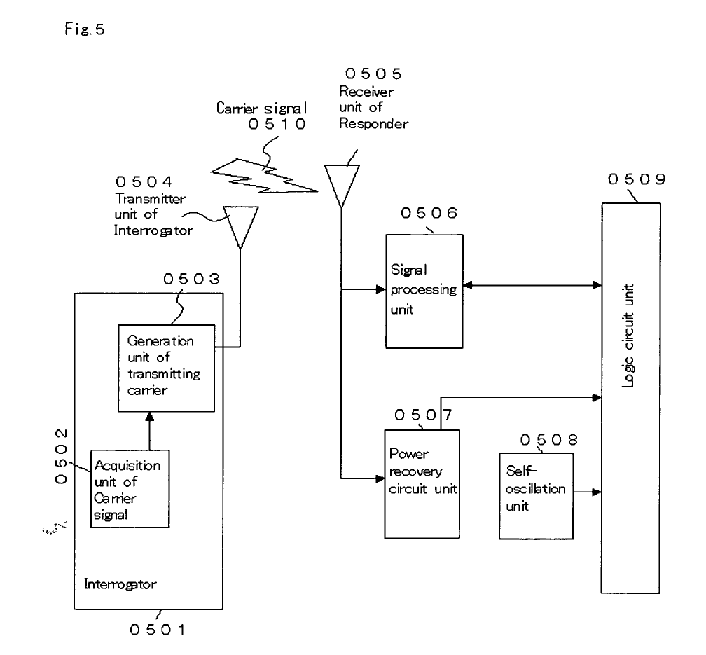

FIG. 6 is a block diagram of the non-contact passive IC card system.

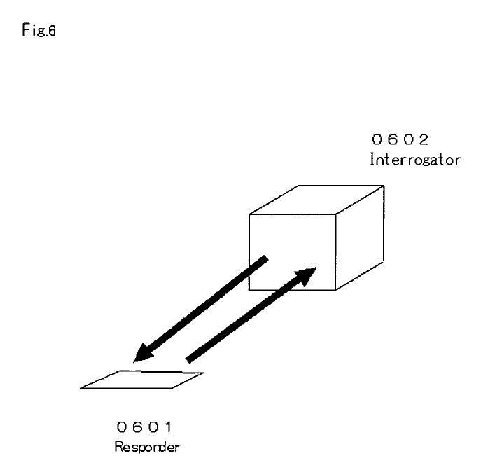

FIG. 7 is a functional block diagram of the non-contact passive IC card system of the third embodiment.

FIG. 8 is a view of explanation for the third embodiment.

### DETAILED DESCRIPTION

### The First Embodiment

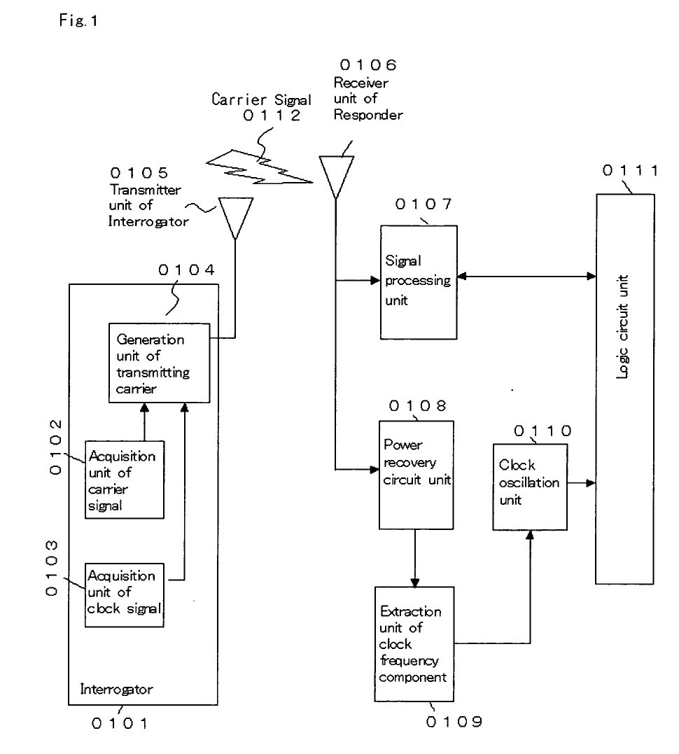

As shown in FIG. 1, the interrogator 0101 comprises the generation unit of carrier signal 0102, the generation unit of clock signal 0103, the generation unit of transmitting signal 0104, and the transmitter unit of interrogator 0105. The responder comprises the receiver unit of the responder 0106, the signal processing unit 0107, the power recovery circuit unit 0108, the extraction unit of clock frequency component 0109, the clock oscillation unit 0110. The common system comprises the above configuration and the logic circuit unit 0111 in the responder.

The generation unit of carrier signal 0102 generates information signal modulates the carrier utilizing microwave. Here, “microwave” corresponds to wave of frequencies such as the wave in VHF-band (30 MHz˜300 MHz), UHF-band (300 MHz˜3 GHz), and SHF-band (3 GHz˜30 GHz). Moreover, “carrier signal” corresponds to carrier signal, which is modulated by a carrier utilizing microwave.

The generation unit of clock signal 0103 generates the clock signal supplied to the clock oscillation unit 0110, which performs time management of the circuit in the responder.

The generation unit of transmitting signal 0104 generates a transmitting signal by multiplexing the carrier signal generated by the generation unit of carrier signal 0102 and the clock signal generated by the generation unit of clock signal 0103.

The transmitter unit of interrogator 0105 transmits the multiplexed carrier signal 0112.

The receiver unit of the responder 0106 receives the carrier signal 0112.

The signal processing unit 0107 processes the signal of the transmitting signal from the interrogator 0101, which has been received by the receiver unit of the responder 0106. The signal processing unit 0107 comprised a microwave circuit. Here, “microwave circuit” corresponds to a circuit for processing microwave frequency, and typically includes expensive high-frequency components.

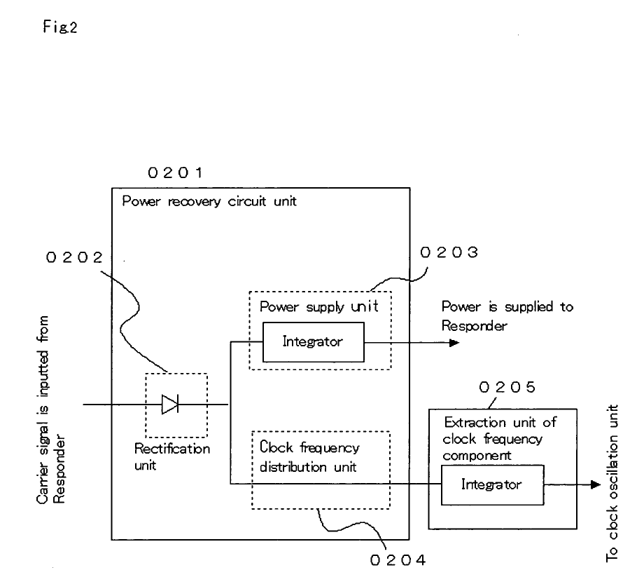

The power recovery circuit unit 0108 generates power by the transmitting signal from the interrogator 0101, which has been received by the receiver unit of the responder 0106, and distributes the transmitting signal to the extraction unit of clock frequency component 0109. For example, as shown in FIG. 2, the power recovery circuit unit 0201 comprises the rectification unit 0202, the power-supplying unit 0203, and the clock frequency distribution unit 0204. The rectification unit 0202 rectifies the transmitting signal from the interrogator, which has been received by the receiver unit of the responder. The power-supplying unit 0203 supplies power to the responder. The clock frequency distribution unit 0204 distributes the clock frequency to the extraction unit of clock frequency component 0205. The power-supplying unit 0203 comprises an integrator etc. By increasing the integral time constant, the direct-current component may be extracted from the output of the rectification unit 0202.

Moreover, the clock frequency distribution unit 0204 distributes output from the rectification unit 0202 to the extraction unit of clock frequency component 0205.

The extraction unit of clock frequency component 0109 extracts the clock frequency component from the transmitting signal from the interrogator, which has been distributed from the power recovery circuit unit 0108. For example, as shown in FIG. 2, the extraction unit of clock frequency component 0205 comprises an integrator etc. By shortening the integral time constant, the clock oscillation frequency component may be extracted from the output of the clock frequency distribution unit 0204 in the power recovery circuit unit 0201.

The clock oscillation unit 0110 generates by utilizing the clock frequency component, which has been extracted by the extraction unit of clock frequency component 0109, and performs time management of the circuit in the responder.

Hereinafter, the operation of the present invention will be described.

The carrier signal (e.g. microwave), which is modulated by the information in the responder 0101 or non-modulated wave, and the frequency component for selecting frequency of the clock oscillation unit 0110 in the responder are multiplexed and modulated. The carrier signal 0112, which is multiplexed, is transmitted from the transmitter unit of the interrogator 0105 (e.g. transmitting antenna) to the responder. In responder, the carrier signal received by the receiver unit of the responder 0106 (e.g. reception antenna) is distributed, and one portion thereof is inputted to the signal processor unit 0107 and another portion thereof is inputted to the power recovery circuit unit 0108. The power generated in the power recovery circuit unit 0108 is supplied to the signal processing unit 0107 (e.g. microwave circuit), the clock oscillation unit 0110, and the logic circuit unit 0111 etc.

The extraction unit of clock frequency component 0109 is connected to the power recovery circuit unit 0108. The power recovery circuit unit 0108 distributes the carrier signal received from the receiver unit of responder 0106 to the extraction unit of clock frequency component 0109, and the extraction unit of clock frequency component 0109 extracts the clock frequency component of the circuit of the entire responder. The extraction unit of clock frequency component 0109 extracts the clock frequency component by utilizing, for example, ASK (Amplitude Shift Keying) reception circuit etc., and supplies information of the clock frequency to the clock oscillation unit 0110.

Thus, the frequency information for the operation in stable oscillation frequency is supplied to the clock oscillation unit 0110.

The clock oscillation unit 0110 performs as a clock generator performing all time management in the responder, and the clock is inputted to the logic circuit unit 0111. Then, energy of the carrier signal attenuates depending on the communication distance, thereby causing fluctuation in the supply voltage. Even in the above case, according to the method of the present invention, it is able to manage the frequency of the clock oscillation unit 0110 by the clock frequency transmitted from the responder 0101, thereby resolving the deficiency that the clock frequency in the responder fluctuates and the information transmission rate of the circuit signal from the responder to the interrogator fluctuates depending on the distance between the responder and the interrogator.

Note that, in the above description, the extraction unit of clock frequency component 0109 is connected to the power recovery circuit unit 0108, and receives the carrier signal, which has been received from the receiver unit of responder 0106, from the power recovery circuit unit 0108; however, the present invention is not limited to the above embodiment.

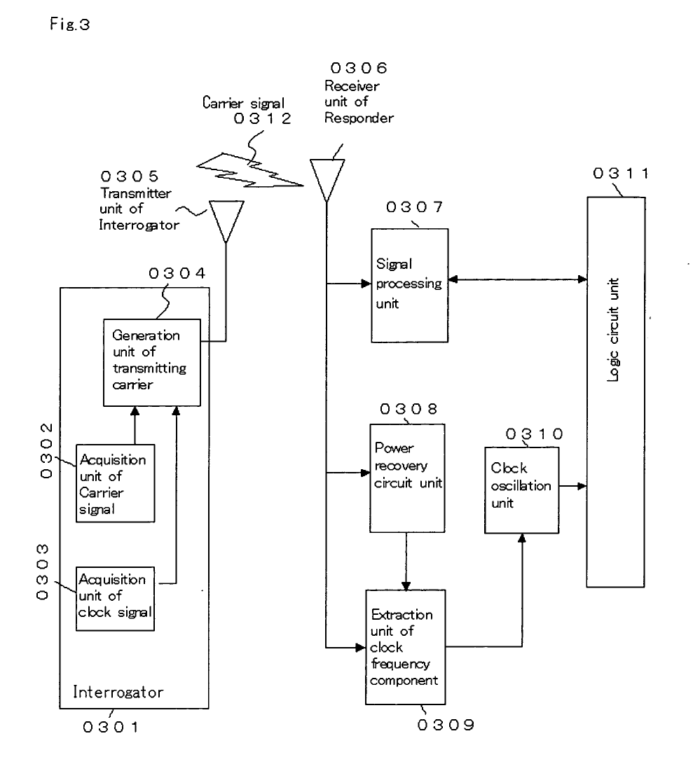

As shown in FIG. 3, the extraction unit of clock frequency component 0309 is able to receive the carrier signal directly from the receiver unit of responder 0106.

In the above case, the interrogator 0301 of the non-contact passive IC card system comprises the generation unit of carrier signal 0302, the generation unit of clock signal 0303, the generation unit of transmitting signal 0304, and the transmitter unit of interrogator 0305. The responder comprises the receiver unit of the responder 0306, the signal processing unit 0307, the power recovery circuit unit 0308, the extraction unit of clock frequency component 0309, and the clock oscillation unit 0310. As in the first embodiment, the common system comprises the above embodiment and the logic circuit unit 0311 in the responder.

The logic circuit unit 0111 in the responder is comprised therewith.

In the embodiment of FIG. 3, the power recovery circuit unit 0308 recovers the power by the transmitting signal from interrogator 0301 received by the receiver unit of the responder 0306.

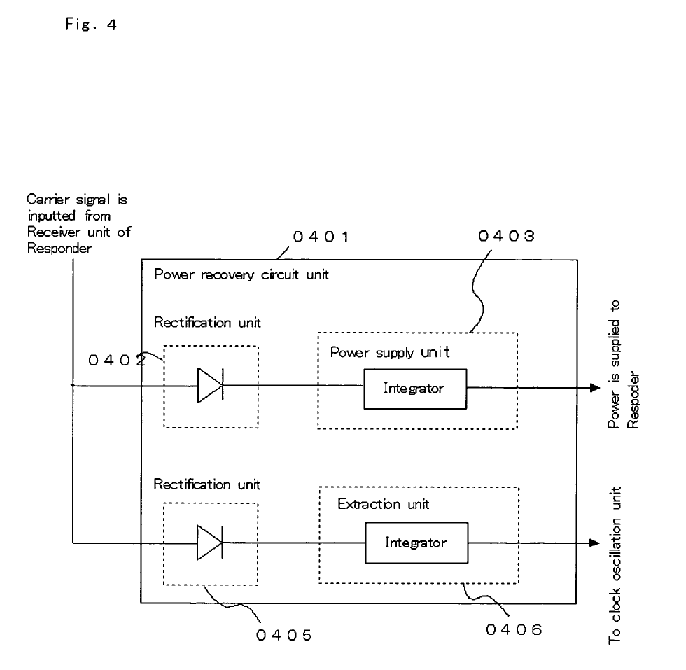

For example, as shown in FIG. 4, the power recovery circuit unit 0401 comprises the rectification unit 0402, and the power supply unit 0403. The rectification unit 0402 rectifies the transmitting signal from the interrogator, which has been received by the receiver unit of the responder. The power-supplying unit 0403 supplies power to the responder. The power supply unit 0403 comprises an integrator etc. By increasing the integral time constant, the direct-current component may be extracted from the output of the rectification unit 0402.

Moreover, the extraction unit of clock frequency component 0309 extracts the clock frequency component from the transmitting signal from interrogator 0301 received by the receiver unit of the responder 0306. For example as shown in FIG. 4, the extraction unit of clock frequency component 0404 comprises the rectification unit 0406 and the extraction unit 0406. The rectification unit 0406 rectifies the transmitting signal from the interrogator, which has been received by the receiver unit of the responder. The extraction unit 0406 comprises the integrator etc. By shortening the integral time constant, the clock oscillation frequency component may be extracted from the transmitting signal of the interrogator, which has been received by the receiver unit of the responder.

### The Second Embodiment

The IC card system of the second embodiment of the present invention is characterized in that a carrier frequency at 2.45 GHz, and clock frequency from several hundred kHz to several dozen MHz are used.

### The Third Embodiment

The third embodiment of the present invention relates to the responder or to the non-contact passive IC card system according to the first embodiment, wherein the signal processing unit comprises a demodulation means for sampling and demodulating the transmitting signal received from the interrogator according to the clock frequency component oscillated by the clock oscillation unit.

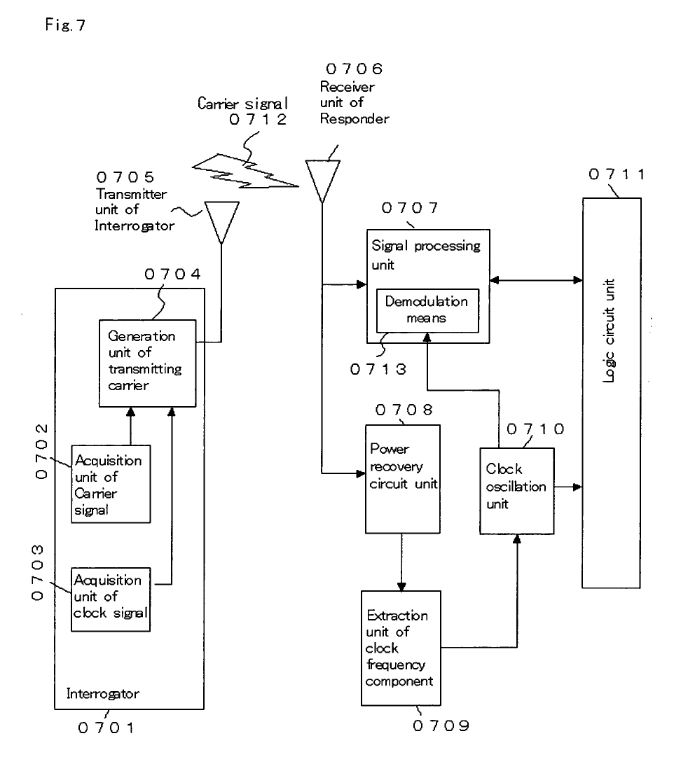

As shown in FIG. 7, the interrogator 0701 of the non-contact passive IC card system of the third embodiment comprises the generation unit of carrier signal 0702, the generation unit of clock signal 0703, the generation unit of transmitting signal 0704, and the transmitter unit of interrogator 0705. The responder comprises the receiver unit of the responder 0706, the signal processing unit 0707, the power recovery circuit unit 0708, the extraction unit of clock frequency component 0709, and the clock oscillation unit 0710. Moreover, the signal processing unit 0707 comprises the demodulation means 0713. The common system comprises the above embodiment and the logic circuit unit 0711 in the responder. Furthermore, The carrier signal 0712 is transmitted from the interrogator 0701.

Hereinafter, the third embodiment of the present invention includes a signal processing unit that comprises the demodulation means for sampling and demodulating the transmitting signal received from the interrogator by the clock frequency component oscillated by the clock oscillation unit will be described. Otherwise, the third embodiment is substantially the same as that of the first and the second embodiments.

### Demodulation Means

The demodulation means performs sampling and demodulation of the transmitting signal received from the interrogator by the clock frequency component oscillated by the clock oscillation unit.

In wireless communication, in order to reduce noise, a limitation is generally set on the passband of the transmitting signal by a circuit, however, the transmitting signal (square wave) becomes distorted.

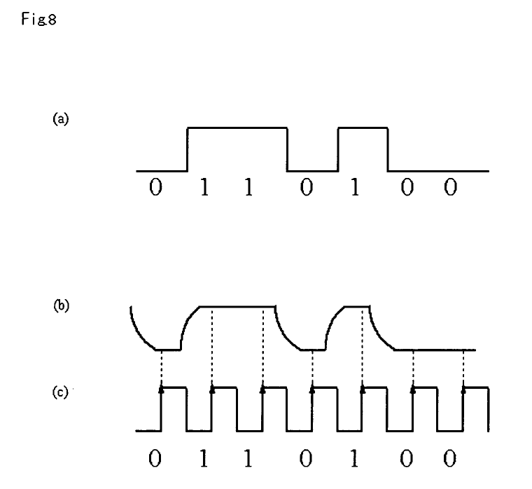

FIG. 8(a) is an illustration of an undistorted wave pattern of the transmitting signal (square wave). FIG. 8(b) is an illustration of a wave pattern of the transmitting signal distorted by the band-limiting upon passage of the transmitting signal of FIG. 8(a) through the transmission path. In order to demodulate “0 ” and “1” from the distorted wave pattern in FIG. 8(b), by sampling on the leading edge (or trailing edge) of the clock signal pattern oscillated by the clock oscillation unit in FIG. 8(c), it becomes able to regenerate data with a low code error rate.

As described hereinabove, by utilizing the clock frequency component oscillated by the clock oscillation unit, the demodulation means becomes able to perform accurate sampling of the transmitting signal received from the interrogator, and demodulation of the information with a low code error rate.

In the non-contact passive IC card system utilizing microwave, which is able to implement miniaturization, high-speed and high-capacity, it is difficult to generate the clock signal by receiving and directly separating the carrier transmitted from the interrogator in the responder. Accordingly, in the system utilizing microwave as a carrier, a self-oscillation unit is utilized as a clock oscillation unit for performing time management of circuit in the responder. Meanwhile, the power voltage recovered in the power recovery circuit unit in the responder depends on the distance between the interrogator and the responder. In the non-contact passive system utilizing microwave, it is difficult to provide a voltage stabilization circuit etc. for an operation at low voltage during power recovery because of the limitations on both the size of the circuit in the responder and the energy of the carrier signal. Accordingly, the circuit in the responder is directly affected by the fluctuation of power voltage. Therefore, it is difficult for a self-oscillation unit, in which the fluctuation of power voltage changes the oscillation frequency, to perform stable time management in the responder.

According to the method of the present invention, the energy of the carrier signal (e.g. microwave) attenuates depending on the communication distance between the interrogator and the responder, so that, even when the power voltage in the responder fluctuates, it is able to control frequency of the clock oscillation unit in the responder by the clock frequency component transmitted from the interrogator, thereby resolving the deficiency of fluctuation of the clock frequency in the responder.

As described hereinabove, according to the present invention, by the construction of FIGS. 1 and 3, it becomes able to avoid the fluctuation of the clock oscillation frequency in the responder in the conventional method, thereby enabling stability, high-speed and high-capacity of communication, simplification of the demodulation circuit in the interrogator, simplification and miniaturization of the circuit of the responder, an increase of communication distance, and an increase in the number of responders such as multi-reader.

What is claimed is:

1. A non-contact passive IC card system comprising
an interrogator, and a responder; wherein
said interrogator comprises
a generation unit for generating carrier signal by utilizing microwave as carrier,
a generation unit of clock signal for time management of a circuit in said responder,
a generation unit for generating transmitting signal by multiplexing the carrier signal generated by said generation unit for generating a carrier signal and the clock signal generated by said generation unit for generating a transmitting signal, and
a transmitter unit for transmitting a transmitting signal generated by said generation unit for generating a transmitting signal; and
said responder comprises
a receiver unit of the responder for receiving the transmitting signal from the transmitter unit of said interrogator,
a signal processing unit for processing the transmitting signal received from said receiver unit of the responder,
a power recovery circuit unit for generating power by the transmitting signal received from said receiver unit of the responder,
an extraction unit of clock frequency component for extracting a frequency component of said clock signal by the transmitting signal received from said receiver unit of the responder, and
a clock generation unit for time management of a circuit in said responder by the clock frequency component extracted by said extraction unit of clock frequency component.

2. An interrogator for a non-contact passive IC card system with a responder, comprising
a generation unit for generating carrier signal utilizing microwave as a carrier,
a generation unit of clock signal for time management of a circuit in said responder,
a generation unit for generating a transmitting signal by multiplexing the carrier signal acquired by said generation unit for generating carrier signal and the clock signal generated by said generation unit for generating a transmitting signal, and
a transmitter unit for transmitting a transmitting signal generated by said generation unit for generating a transmitting signal.

3. A responder for a non-contact passive IC card system with an interrogator, comprising
a receiver unit of the responder for receiving the transmitting signal from the transmitter unit of said interrogator,
a signal processing unit for processing the transmitting signal received from said receiver unit of the responder,
a power recovery circuit unit for generating power by the transmitting signal received from said receiver unit of the responder,
an extraction unit of clock frequency component for extracting a frequency component of said clock signal by the transmitting signal received from said receiver unit of the responder, and
a clock generation unit for time management of a circuit in said responder by the clock frequency component extracted by said extraction unit of clock frequency component.

4. An operation method of a non-contact passive IC card system comprising an interrogator and a responder; wherein
said interrogator executes a process comprising
a generation step of generating carrier signal by utilizing microwave as a carrier,
a generation step of clock signal for time management of a circuit in said responder,
a generation step of generating a transmitting signal by multiplexing the carrier signal generated by said generation step of generating carrier signal and the clock signal generated by said generation step of generating transmitting signal, and
a transmission step of transmitting a transmitting signal generated by said generation step of generating a transmitting signal; and
said responder executes a process comprising
a reception step in the responder of receiving the transmitting signal from the transmission step in said interrogator,
a signal processing step of processing the transmitting signal received from said reception step in the responder,
a power recovery step of generating power by the transmitting signal received from said reception step in the responder,
an extraction step of clock frequency component of extracting a frequency component of said clock signal by the transmitting signal received from said reception step in the responder, and
a clock generation step for time management of a circuit in said responder by the clock frequency component extracted by said extraction step of clock frequency component.

5. The IC card system according to claim 1, wherein
a frequency of said microwave is included in VHF-band (30 MHz˜300 MHz), UHF-band (300 MHz˜3 GHz), and SHF-band (3 GHz˜30 GHz).

6. The non-contact passive IC card system according to claim 1, wherein
said signal processing unit comprises a demodulation means for sampling and demodulating the transmitting signal received from the interrogator according to the clock frequency component oscillated by the clock oscillation unit.

7. The responder according to claim 3, wherein
said signal processing unit comprises a demodulation means for sampling and demodulating the received transmitting signal from the interrogator according to the clock frequency component oscillated by the clock oscillation unit.

8. The operation method of the non-contact passive IC card system according to claim 4, wherein
said signal processing step includes a process comprising a demodulation step of sampling and demodulating the received transmitting signal from the interrogator according to the clock frequency component oscillated by the clock oscillation unit.
